(19) United States
(12) Patent Application Publication
(10) Pub. No.: US 2009/0125583 A1
(43) Pub. Date: May 14, 2009

(54) PRIORITY CONTROL SYSTEM AND METHOD

(75) Inventors: Shinichi HAYASHI, Kawasaki (JP); Hiroshi Saito, Kawasaki (JP); Yukio Ogawa, Tokyo (JP); Nobuyuki Fujieda, Kawasaki (JP); Yuji Kimura, Kawasaki (JP)

Correspondence Address: MCDERMOTT WILL & EMERY LLP, 600 13TH STREET, N.W., WASHINGTON, DC, 20005-3096, US

(73) Assignee: HITACHI, LTD

(21) Appl. No.: 12/266,963

(22) Filed: Nov. 7, 2008

(30) Foreign Application Priority Data
Nov. 8, 2007 (JP) 2007-290282

(51) Int. Cl. G06F 15/16

(52) U.S. Cl. 709/203; 709/207

(57) ABSTRACT

A priority control system includes a terminal, and a processing server coupled over a network. The processing server has an operation processing sections each of which executes a predetermined process, a communications device, a priority determination section, and a priority assignment section. The processing server also has priority information about priorities to be assigned according to a type of operation processing section. Each of the operation processing sections executes the predetermined process based on a packet, provided by the terminal, and generates screen information with a result of the predetermined process. The communications device transmits screen information with an assigned priority. The terminal receives the screen information transferred by a network device on the network in accordance with the priority, and displays the screen information.

### INCORPORATION BY REFERENCE

This application claims priority based on a Japanese patent application, No. 2007-290282 filed on Nov. 8, 2007, the entire contents of which are incorporated herein by reference.

### BACKGROUND OF THE INVENTION

The present invention relates to priority control over network traffic in a client server system of a screen transfer type.

With the recently-well-equipped network environment, notebook personal computers (hereinafter, referred to as “note PCs”) have become popular and available in various business situations. It indeed offers convenience, but also increases the risk of loss and theft of the note PCs. The increase of risk of loss and theft means also the increase of risk of leakage of confidential information stored in hard disk drives of the note PCs. Various attempts have been thus actively made to reduce such a risk of information leakage.

As measures against such a risk of information leakage, there is a system called thin client system for reducing data stored in a computer such as note PC a user directly operates.

The thin client system is configured by a thin client terminal, and a thin client server. The thin client system is implemented with screen transfer or network boot, for example. In a thin client system implemented with screen transfer, when a coupling is established with any thin client terminal, a work area called virtual desktop is formed on the thin client server for a user of the thin client terminal. On the virtual desktop, one or more windows are displayed, and through the window(s), the user remotely operates an application on the thin client server. The virtual desktop is created on a user basis, and the window on the virtual desktop is created also on a user basis. As such, the virtual desktop and the window(s) cannot be remotely operated by any other users.

The thin client terminal is exemplified by a computer such as note PC a user directly operates. The thin client terminal has a function of forwarding any information directly input by the user to the thin client server, and displaying screen information coming from the thin client server. The thin client server has a function of receiving any input information from the thin client terminal, and based on the processing result of the input information, generating screen information for transmission to the thin client terminal. With such functions, when the user operates the thin client terminal, the operation result is accordingly displayed on the thin client terminal so that the user can go through the operation with a program as if it was running on the thin client terminal.

The thin client terminal stores information for establishing a coupling to the thin client server, and any information created by the user is stored in the thin client server. Such data storage can reduce the risk of leakage of user-created information even if the thin client terminal is lost or stolen. The thin client system is described in Patent Document 1 (JP-A-2004-94411), for example.

Patent Document 1 describes a technology for information creation and storage on a thin client server by a user operating a thin client terminal.

There is also a technology for changing priorities for packet transfer in accordance with the transmission sources and destinations of packets, and the type of communications. In another technology, the priorities for packet transfer are changed in accordance with information about priorities assigned to the packets. Such technologies are found in Postel, J., “Internet Protocol”, September 1981, IETF, <URL: http://www.ietf.org/rfc/rfc0791.txt>, Almquist, P., “Type of Service in the Internet Protocol Suite”, July 1992, IETF, <URL: http://www/ietf.org/rfc/rfc1349.txt>, and others.

### SUMMARY OF THE INVENTION

With the technologies described in the above documents, information exchanged between the thin client terminal and the thin client server is image information. This information includes information input from the thin client terminal to the thin client server for operation of business applications, and information provided from the thin client server to the thin client terminal as a result of operation of the business applications. As such, no matter what type of business application is in progress in each of the thin client server, the incoming packet offers no clue which thin client terminal is the destination of communications. Although the packets are each provided with an identifier indicating the type of communications, it merely indicates the thin client communications, and thus there is still no clue about which thin client terminal is the destination of communications. As such, even if such technologies are applied to the thin client system, the thin client terminal during operation of any important business application cannot be a destination of a communications packet with a higher priority.

During communications with the thin client terminal and the thin client server, a large number of packets may mainly gather over a network, and thus packet congestion may occur in a network device configuring the network. If packet congestion occurs as such, some delay is caused in communications related to any important business application.

Packet congestion may also occur in the network device if there is a difference of network bandwidth between the thin client server and the network device, between the thin client terminal and the network device, and between the network devices. If packet congestion occurs as such, some delay is also caused in communications related to the important business application. Such a delay of business application adversely affects the implementation of business in its entirety.

As such, there is a need to reduce such adverse effects on business operations through prevention of occurrence of delay.

The disclosed system provides means for performing priority control over communications with effectiveness also in a thin client system.

For achieving the above-described object, the disclosed system provides a priority control system that performs priority control over communications with thin client terminals based on a business application in progress.

To be specific, determining the priorities of thin client terminals may be based on the priorities assigned to applications in progress in each operation client processing system of the thin client server. Then, transfer priorities of communications packets coming from the thin client server, e.g. with image information, may be based on the resulting priorities. Such priority determinations may use an application in progress in any active window of each of the thin client terminals. Alternatively, any business application in progress in any window at the forefront may be used, or any application showing information such as “warning” in a window may be used. Herein, the priorities of applications may be determined in advance, and may be stored in a thin client server.

In a specific example, the priority control system is characteristically provided with a plurality of terminals and at least one processing server coupled with the terminals over a network. In the system, the processing server(s) includes: a plurality of operation processing sections each for executing a predetermined process; a communications device; a priority determination section; and a priority assignment section. The processing server(s) is provided with priority information about priorities to be assigned in accordance with respective types of the operation processing sections. The operation processing sections each execute a respective predetermined process based on a packet provided by one of the terminals, and generate terminal screen information to be displayed on the one terminal with a result of the respective predetermined process. The priority assignment section assigns, to the terminal screen information from the operation processing sections, priorities determined in accordance with the respective types of the operation processing sections. The communications device transmits the terminal screen information assigned with the priorities by the priority assignment section, and the terminal screen information is transferred by a network device on the network in accordance with the priorities assigned to the terminal screen information, and is transmitted to the terminals for display.

In such a priority control system, with the operation processing section plurally provided, the priority determination section determines any of the operation processing sections for assignment of the priorities in accordance with a state of use of the operation processing sections in the processing servers.

Herein, the state of use of the operation processing sections includes whether a window on a screen corresponding thereto is active or not, or is used as a window at the forefront or not, or any failure is observed or not in a process to be executed by the operation processing sections.

When the network is provided plurally, the communications device may change the network in accordance with the priorities of the terminal screen information for transmission thereof.

The terminals may assign priorities, to packets for transmission to the processing servers, the same as those assigned to the terminal screen information coming from the processing servers.

When the priority control system further includes an operation server, and when the operation processing sections each execute the predetermined process through communications with the operation server, the network device may include second priority information with details determined in accordance with the operation server. By following the second priority information, the network device may transfer a packet to be exchanged between the operation processing sections and the operation server. Herein, the second priority information may include information about priorities defined by an identifier assigned to the packet for identification of communications type.

According to the teachings herein, priority control can be applied over communications in accordance with the details of business application.

Other concepts relate to unique software for implementing the priority control system. A software product or article, in accord with such a concept, includes at least one machine-readable storage medium and information carried by the medium. The information carried by the medium may be executable program code and/or associated priority data for managing the priorities of packets involved in the client-server communications.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a block diagram showing an exemplary configuration of a system;

FIG. 2 is a block diagram showing an exemplary configuration of a thin client server;

FIG. 3 is a block diagram showing an exemplary configuration of an operation server;

FIG. 4 is a block diagram showing an exemplary configuration of a network device;

FIG. 5 is a block diagram showing an exemplary configuration of a thin client terminal;

FIG. 6 is a diagram showing exemplary details set to a priority determination section;

FIG. 7 is a diagram showing exemplary details set to the network device;

FIG. 8 is a flowchart of an exemplary process flow of the priority determination section;

FIG. 9 is a flowchart of an exemplary process flow of a priority assignment section;

FIG. 10 is a flowchart of another exemplary process flow of the priority assignment section;

FIG. 11 is a flowchart of still another exemplary process flow of the priority assignment section;

FIG. 12 is a flowchart of an exemplary process flow of the network device;

FIG. 13 is a diagram showing exemplary image information of a virtual desktop 1; and

FIG. 14 is a diagram showing exemplary image information of a virtual desktop 2.

### DETAILED DESCRIPTION OF THE EMBODIMENTS

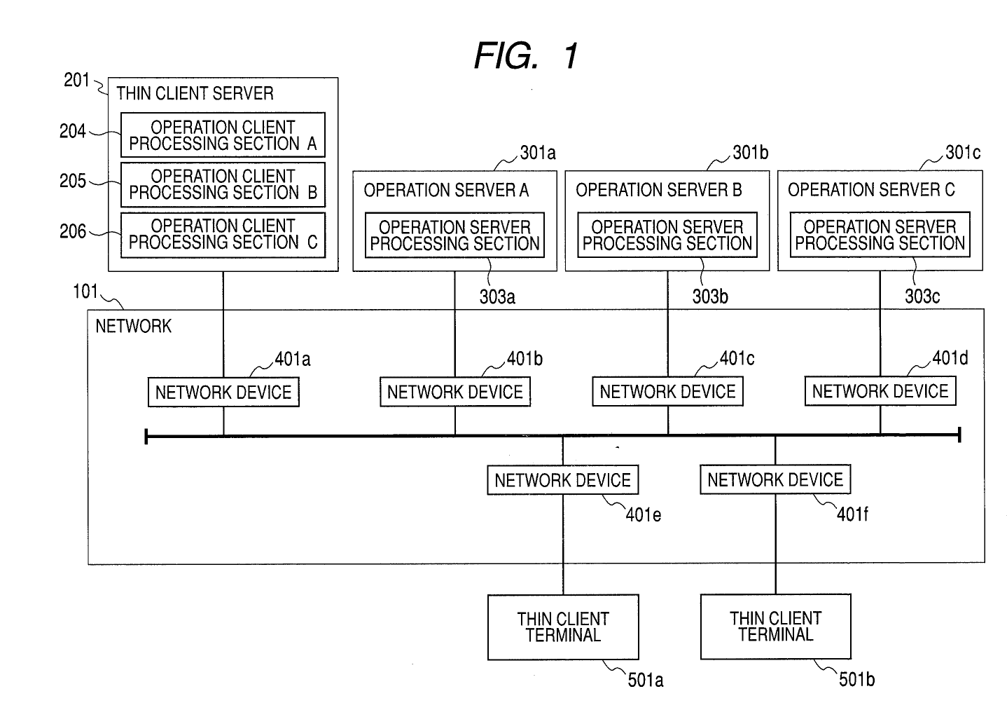

In the below, examples are described by referring to FIGS. 1 to 14.

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

FIG. 1 is a block diagram showing the configuration of a thin client system of this embodiment. This system is configured to include a network 101, a thin client server 201, an operation server A 301a, an operation server B 301b, an operation server C 301c, and thin client terminals 501 (501a and 501b). The network 101 is configured to include network devices 401 (401a, 401b, 401c, 401d, 401e, and 401f). The network 101 establishes a coupling among the components, i.e., the thin client server 201, the operation server A 301a, the operation server B 301b, the operation server C 301c, and the thin client terminals 501 (501a and 501b). This embodiment exemplifies the configuration with a server and two terminals, but the number of servers and the number of terminals are not surely restrictive.

The network device 401 herein is exemplified by a router, and as will be described later, is provided with a function of performing data transfer in accordance with priorities. The network 101 may be a Wide Area Network (WAN), or a Local Area Network (LAN). The business application is configured to include an operation client processing section operating on the thin client server 201, and an operation server processing section operating on each of the operation servers 301. To be specific, the business application A is configured to include an operation client processing section A 204 on the thin client server 201, and an operation server processing section 303a on the operation server A 301a. The business application B is configured to include an operation client processing section B 205 on the thin client server 201, and an operation server processing section 303b on the operation server B 301b. The business application C is configured to include an operation client processing section C 206 on the thin client server 201, and an operation server processing section 303c on the operation server C 301c.

Note that, the components including the operation client processing sections 204 to 206 and the operation server processing section 303, i.e., processing sections, determination sections, and assignment sections described below, are implemented by a central processing unit (CPU) of a computer or the like running a program after reading into a main storage device or medium. This program may be one stored in an external storage device e.g. external with respect to the main storage device, in any device with the processing section. The program may be installed into an external storage device when required via any attachable/detachable storage medium or communications medium, e.g., cable network, wireless network, optical network, or carrier and digital signal on such networks.

The business application is exemplified by an accounting management application, an employees' performance appraisal management application, and others. Compared with the performance appraisal management application, the accounting management application is required to be higher in priority as it is money-related and more important.

Described next is the basic operation of the screen-transfer-type thin client system in this embodiment. A user of the thin client system operates the thin client terminal 501 (501a or 501b). The user makes inputs of information using a keyboard and a mouse of the thin client terminal 501 (501a or 501b), and the input information is forwarded to the thin client server 201 coupled over the network 101. The thin client server 201 receives the input information provided by the thin client terminal 501 (501a or 501b), and goes through a process based on the information. Based on the processing result, the thin client server 201 then generates output information such as screen information for transmission to the thin client terminal 501 (501a or 501b). The thin client terminal 501 (501a or 501b) receives the output information provided by the thin client server 201 as such, and outputs the information to an output device such as a display. With such functions, when the user operates the thin client terminal, he or she finds the operation result displayed on the thin client terminal so that the user can go through the operation with a program as if it was running on the thin client terminal.

With such an operation, through operation of the thin client terminal 501, the user of the thin client system can remotely operate other components on the thin client server 201, i.e., the operation client processing section A 204, the operation client processing section B 205, and the operation client processing section C 206.

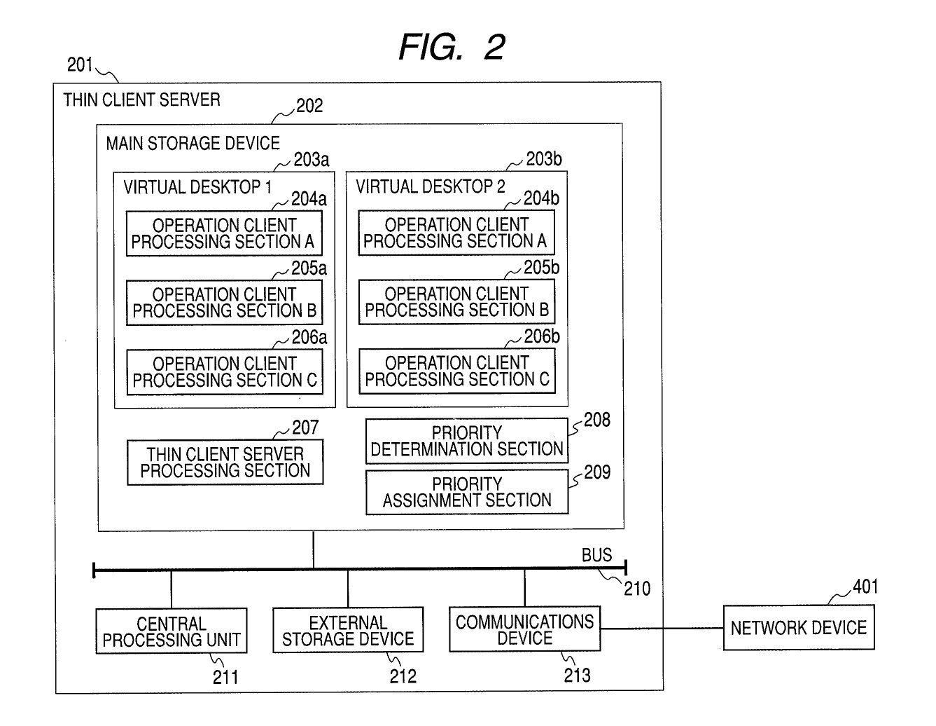

FIG. 2 is a block diagram showing in detail the thin client server 201 of FIG. 1. The thin client server 201 is configured to include a main storage device 202, virtual desktops 203 (203a, 203b), operation client processing sections 204 (204a, 204b, 205a, 205b, 206a, and 206b), a thin client server processing section 207, a priority determination section 208, a priority assignment section 209, an internal communications line 210 such as bus, a CPU 211, an external storage device 212, and a communications device 213. The internal communications line 210 establishes a coupling among the components, i.e., the main storage device 202, the CPU 211, the external storage device 212, and the communications device 213. The communications device 213 is coupled with the network device 401.

The thin client server processing section 207 creates the virtual desktop 203 (203a, 203b) on a thin client terminal basis in response to a coupling established with the thin client terminal 501 (501a, 501b). For use of a business application, the user of the thin client terminal 501 (501a, 501b) activates any corresponding operation client processing sections 204 (204a, 204b, 205a, 205b, 206a, and 206b) in the virtual desktop 203 (203a, 203b). Herein, for example, the image information of a virtual desktop 1 is a piece of image information including image information of two processing sections, i.e., the operation client processing sections A and B.

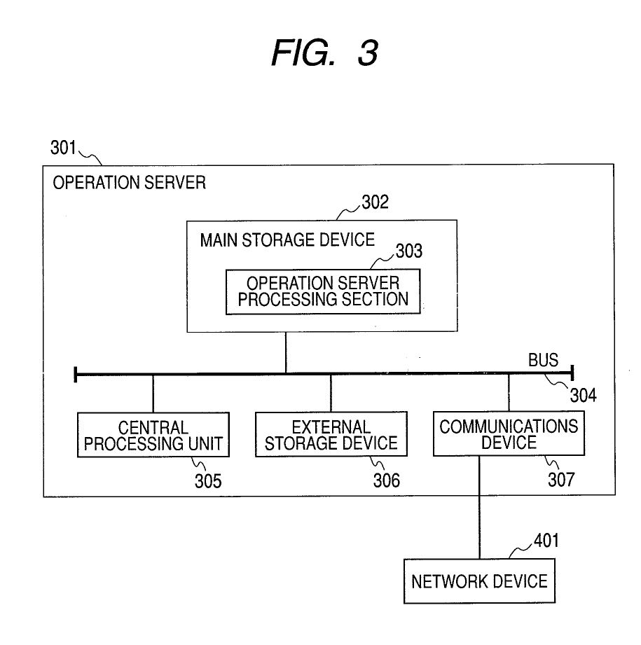

FIG. 3 is a block diagram showing in detail the operation server 301 (301a, 301b, 301c) of FIG. 1. The operation server 301 is configured to include a main storage device 302, an operation server processing section 303, a communications line 304 such as bus, a CPU 305, an external storage device 306, and a communications device 307. The internal communications line 304 establishes a coupling among the components, i.e., the main storage device 302, the CPU 305, the external storage device 306, and the communications device 307. The communications device 307 is coupled with the network device 401. The operation server processing section 303 responds to any request coming from the operation client processing sections (204, 205, and 206).

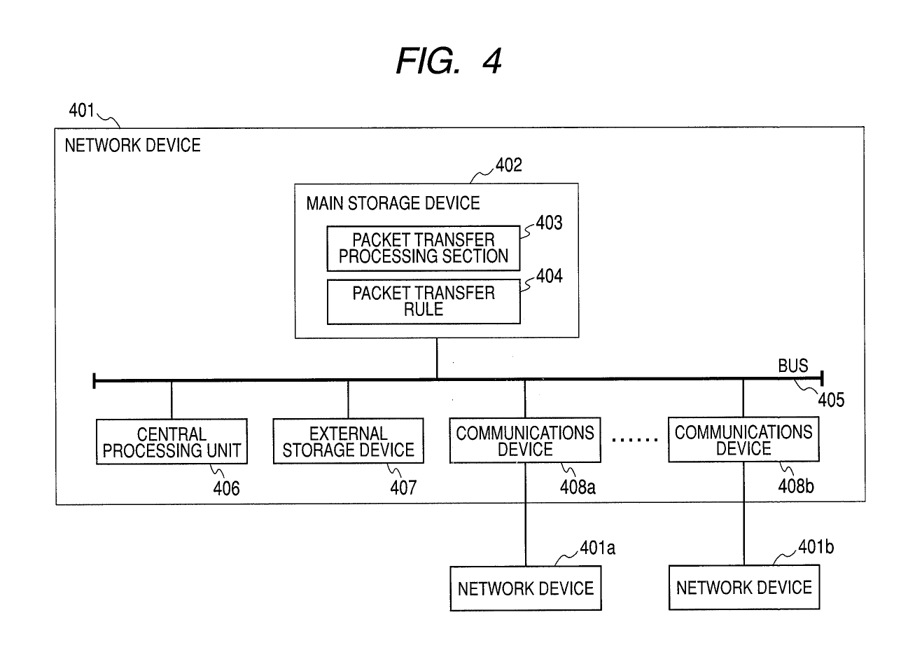

FIG. 4 is a block diagram showing in detail the network device 401 (401a, 401b, 401c, 401d, 401e, 401f) of FIG. 1. The network 401 is configured to include a main storage device 402, a packet transfer processing section 403, a packet transfer rule 404, a communications line 405 such as bus, a CPU 406, an external storage device 407, and a communications device 408 (408a, 408b). The internal communications line 405 establishes a coupling among the components, i.e., the main storage device 402, the CPU 406, the external storage device 407, and the communications device 408 (408a, 408b). The communications devices 408 (408a and 408b) are coupled with the network devices 401 (401 and 401b), respectively. FIG. 4 shows two of the communications devices 408, i.e., 408a and 408b, but the number of the communications devices is not restrictive, and two or more communications devices will do. The packet transfer processing section 403 transfers a packet received by the communications device 408 (408a, 408b) in accordance with the priorities defined by the packet transfer rule 404.

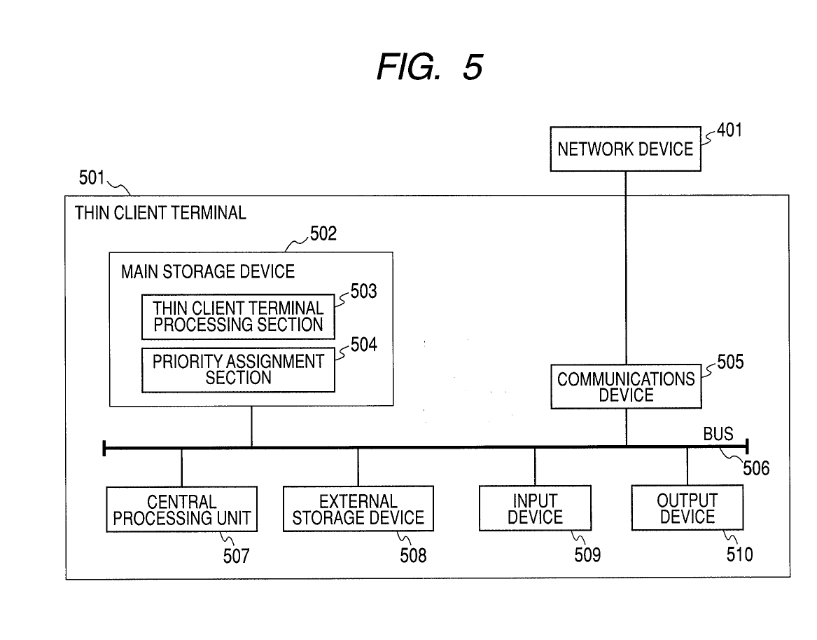

FIG. 5 is a block diagram showing in detail the thin client terminal 501 (501a, 501b) of FIG. 1. The thin client terminal 501 is configured to include a main storage device 502, a thin client terminal processing section 503, a priority assignment section 504, a communications device 505, a communications line 506 such as bus, a CPU 507, an external storage device 508, an input device 509, and an output device 510. The internal communications line 506 establishes a coupling among the components, i.e., the main storage device 502, the communications device 505, the CPU 507, the external storage device 508, the input device 509, and the output device 510. The thin client terminal processing section 503 forwards information provided by the input device 509 to the thin client server 201, and to the output device 510, outputs the output information received from the thin client server 201.

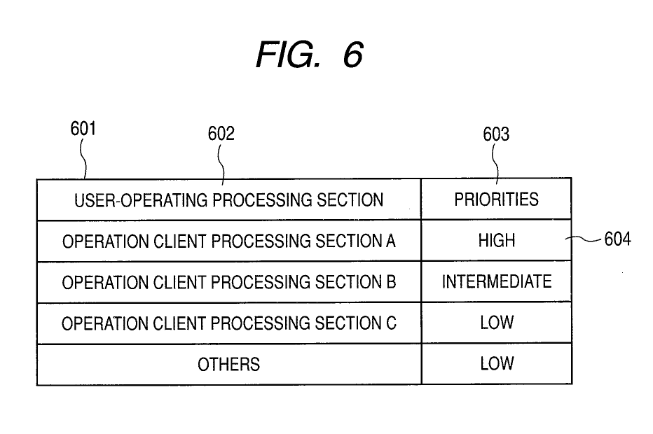

FIG. 6 is a table showing a priority-defining rule, which is set in advance for the priority determination section 208 of FIG. 2. The priority-defining rule of FIG. 6 is for the communications packets to be exchanged between the thin client server and the thin client terminal based on the user-operating processing section. Such a table is stored in the external storage device 212, and when the thin client server 201 is activated, the table is read into the main storage device 202. A line 604 indicates that, while the user is operating the “operation client processing section A”, the priority is set to “high” for a communications packet to be exchanged between the thin client server and the thin client terminal the user is operating.

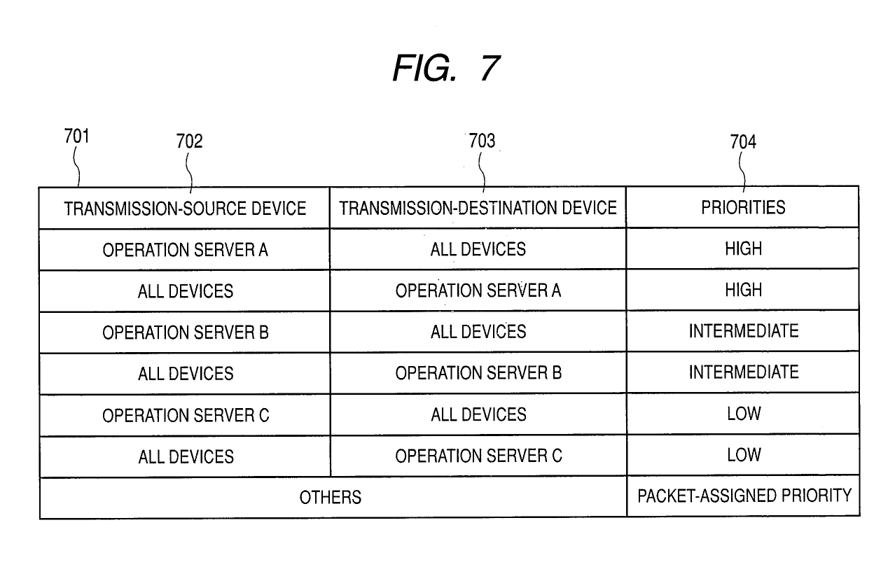

FIG. 7 is a table showing a priority-defining rule, which is set in advance for the packet transfer rule 404 of the network device 401 (401a, 401b, 401c, 401d, 401e, 401f) of FIG. 1. The priority-defining rule of FIG. 7 is for the device of a packet-transmission source and the device of a packet-transmission destination. An element of “transmission-source device 702” indicates values for use to uniquely identify the transmission-source device assigned to each of the transferring packets. An element of “transmission-destination device 703” indicates values for use to uniquely identify the transmission-destination device assigned to each of the transferring packets. The values uniquely identifying the transmission-source devices include IP (Internet Protocol) address and port numbers in an IP network, for example. An element of “priorities 704” indicates the priorities in terms of transferring a packet satisfying both the elements of “transmission-source device 702”, and “transmission-destination device 703”. Any packet not satisfying the elements of “transmission-source device 702”, and “transmission-destination device 703” is transferred with the priority originally assigned thereto. The priority originally assigned to the packet means the value designated by a TOS field (Type of Service) in an IP header, for example. A packet defined as being high in priority is transferred with a higher priority than a packet defined as being low in priority. In this embodiment, the priorities are expressed as “high”, “intermediate”, and “low”, but may be expressed by comparable values such as real numbers. The example shows three priority levels, although other numbers of relative priorities may be used.

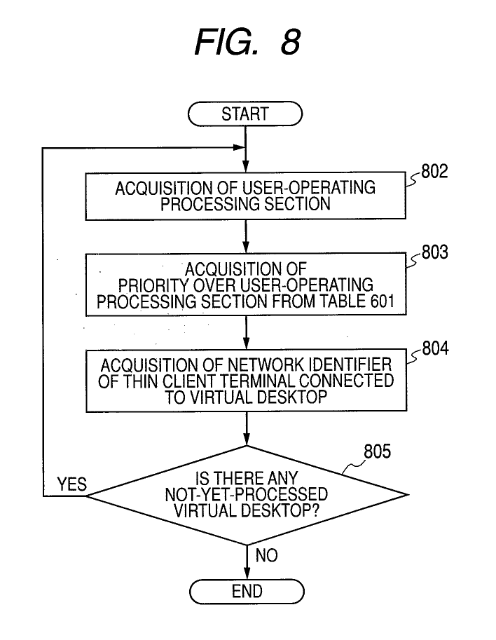

FIG. 8 is a flowchart of a process flow in the priority determination section 208 of FIG. 2. A process 802 is executed for acquiring the type of the operation client processing section a user is operating. The operation client processing section is provided with one or more windows. The operation client processing section the user is operating is the one being an operation target such as input by the user, for example, and having any active window. When a window at the forefront in the virtual desktop is more important than the active window, as an alternative to the active window, a processing section having the forefront window in the virtual desktop may serve as the window of the operation client processing section operated by the user. Note that, even if one window is configured by a plurality of windows, these windows all belong to one operation client processing section. Accordingly, it is possible to know which operation client processing section the user is operating. A process 803 is executed for acquiring the priority of the user-operating operation client processing section from the table 601. A process 804 is executed for acquiring a network identifier of the thin client terminal coupled to any of the virtual desktops. A determination 805 is made to see whether there is any virtual desktop 203 (203a, 203b) not yet through with the processes 802, 803, and 804. When there is any virtual desktop not yet through with the processes 802, 803, and 804, the procedure returns to the process 802. When every virtual desktop is through with the processes 802, 803, and 804, this is the end of the procedure.

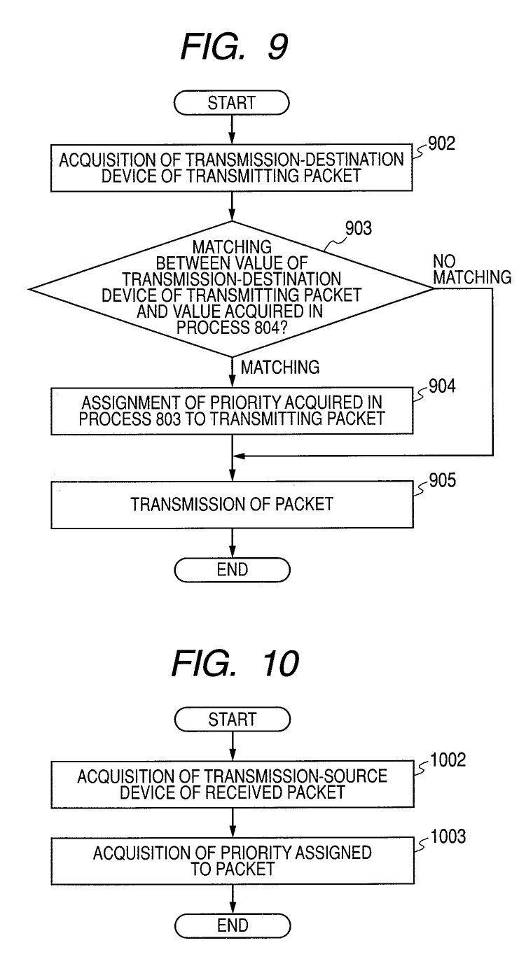

FIG. 9 is a flowchart of a process flow in the priority assignment section 209 of FIG. 2. A process 902 is executed for acquiring the transmission-destination device of a packet to be transmitted by the thin client server. A determination 903 is made to see whether the transmission-destination device of the transmitting packet shows a value the same as that acquired in the process 804. When the value matching is observed, the procedure goes to a process 904. When no value matching is observed, the procedure goes to a process 905. In the process 904, the priority acquired in the process 803 is assigned to the transmitting packet. That is, the screen information of the virtual desktop 203 (203a, 203b) is assigned the priority of the processing section the user is operating. In the process 905, the packet is transmitted.

FIG. 10 is a flowchart of a process flow when the thin client terminal of the priority assignment section 501 of FIG. 5 receives a packet. A process 1002 is executed for acquiring the transmission-source device from which the packet is provided. A process 1003 is executed for acquiring the priority assigned to the packet.

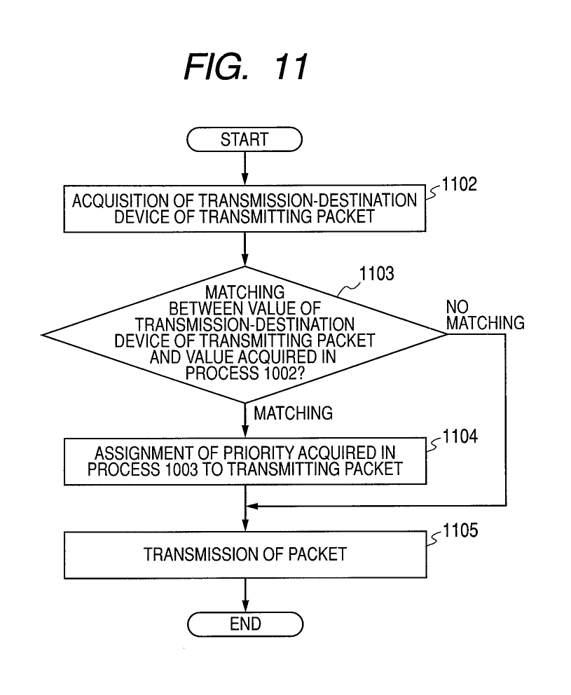

FIG. 11 is a flowchart of a process flow when the thin client terminal of the priority assignment section 501 of FIG. 5 transmits a packet. A process 1102 is executed for acquiring the transmission-destination device of the transmitting packet. A determination 1103 determines whether the transmission-destination device of the transmitting packet shows a value the same as that acquired in the process 1002. In a process 1104, the priority acquired in the process 1003 is assigned to the transmitting packet. In other words, if the intended destination of the packet the terminal is about to transmit is the same as the source of the last packet the terminal received, then the packet to be sent will get the same priority as the last received packet. In a process 1105, the packet is transmitted.

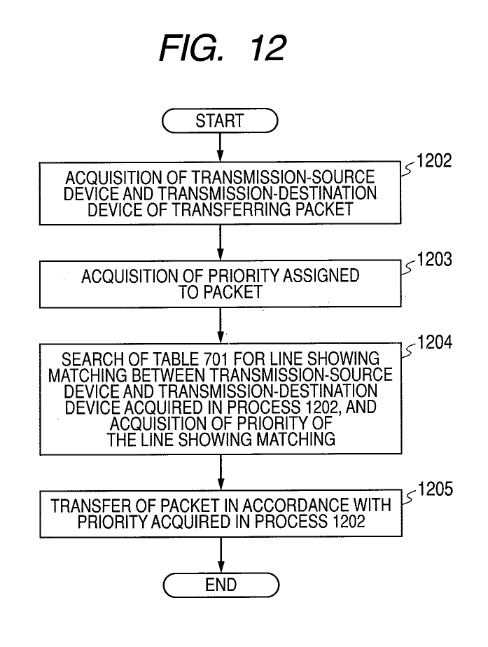

FIG. 12 is a flowchart of a process flow at the time of packet transfer in the network device 401 (401a, 401b, 401c, 401d, 401e, 401f) of FIG. 1. The network devices each go through the following processes at the time of packet transfer. A process 1202 is executed for acquiring the transmission-source device and the transmission-destination device of the transferring packet. A process 1203 is executed for acquiring the priority assigned to the transferring packet. A process 1204 is executed for searching the table 701 for a line showing a matching between the transmission-source device and the transmission-destination device acquired in the process 1202, and acquiring the priority of the line showing the matching. In a process 1205, when the priority of the line showing the matching in the process 1204 can be acquired, thus acquired priority is assigned to the packet for transfer. When such a priority cannot be acquired, packet transfer is performed in accordance with the priority acquired in the process 1203. For packet transfer in accordance with the priorities, for example, the network device 401 may be provided therein with a queue on a priority basis, and even when some packet congestion is observed in the network device 401, any packet showing a higher priority is to be transferred first.

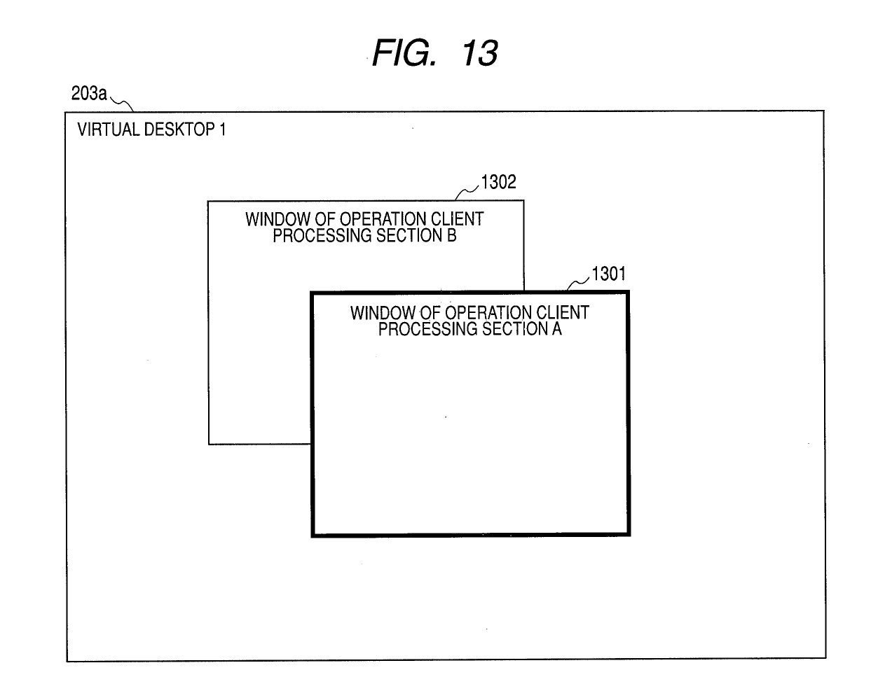

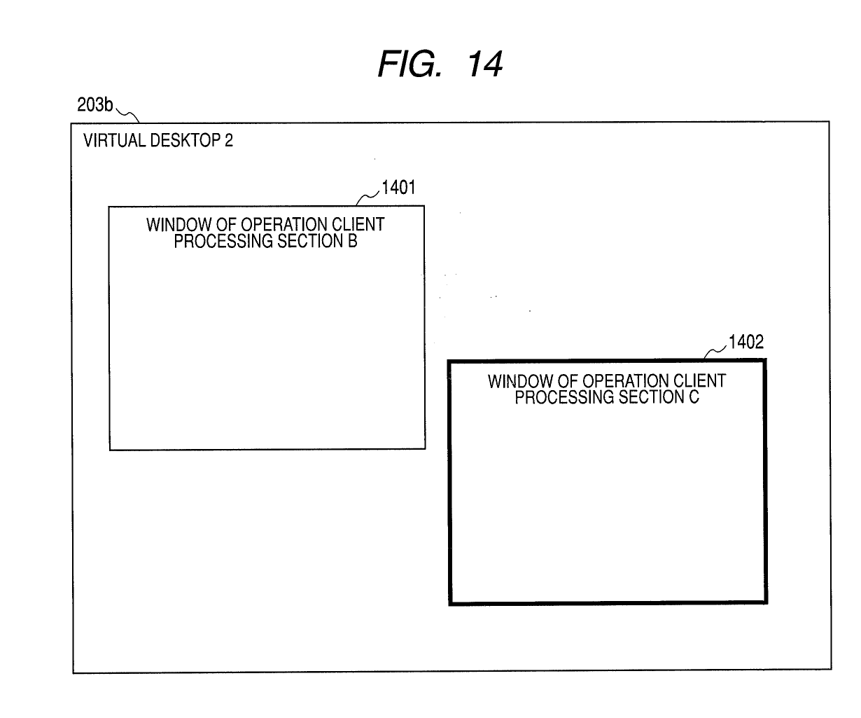

FIG. 13 shows image information of the virtual desktop 1 203a of FIG. 2, and the image information is displayed on the thin client terminal 501a. The image information created by the operation client processing section A is a window 1301, and the image information created by the operation client processing section B is a window 1302. The thin client server processing section 207 creates image information of the virtual desktop 1 203a in combination with these windows 1301 and 1302, and the resulting image information is forwarded to the thin client terminal 501a. The thin client server 201 forwards this image information to the thin client terminal 501a, and the thin client terminal 501a displays this image information on the output device 510. The window enclosed by a thick frame in the drawing indicates that the window is active. In FIG. 13, the window 1301 of the operation client processing section A is active. In this case, in the process 803, the processing section the user is operating corresponds to the window 1301 of the operation client processing section A, and the priority thereof is “high”.

FIG. 14 shows image information of the virtual desktop 2 203b of FIG. 2, and the image information is displayed on the thin client terminal 501b. The image information created by the operation client processing section B is a window 1401, and the image information created by the operation client processing section C is a window 1402. The thin client server processing section 207 creates image information of the virtual desktop 2 203b in combination with these windows 1401 and 1402, and the resulting image information is forwarded to the thin client terminal 501b. The thin client terminal 501b displays this image information on the output device 510. Similarly to FIG. 13, the window enclosed by a thick frame in the drawing indicates that the window is active. In FIG. 14, the window 1402 of the operation client processing section C is active. In this case, in the process 803, the processing section the user is operating corresponds to the window 1402 of the operation client processing section C, and the priority thereof is “low”.

With such a process, when a user operates the operation client processing section A 204 utilizing the thin client terminal 501 (501a, 501b), because the operation client processing section A 204 is active, the priority acquired in the process 803 for the operation client processing section A 204 is thus “high”. Accordingly, packet transfer in the process 1104 is performed with the priority of “high”, and in the network device 401, the element of “others” is applicable in the process 1204 (refer to FIG. 7) so that the packet is transferred with the priority of “high” originally assigned thereto. For the communications between the thin client server 201 and the operation server A 301a, the priority acquired therefor is “high” in the process 1204. As such, the communications for packet transfer between the thin client server 201 and the thin client terminal 501 (501a, 501b) and between the thin client server 201 and the operation server A 301a are all carried out with the priority of “high”. Similarly, for operating the operation client processing section B, the communications for packet transfer between the thin client server 201 and the thin client terminal 501 (501a, 501b) and between the thin client server 201 and the operation server B 301b are all carried out with the priority “intermediate”. For operating the operation client processing section C, the communications are all carried out with the priority of “low”, for packet transfer between the thin client server 201 and the thin client terminal 501 (501a, 501b) and between the thin client server 201 and the operation server C 301c. When none of the operation client processing sections is operated, all the communications is carried out with the priority of “low”, for packet transfer between the thin client server 201 and the thin client terminal 501 (501a, 501b).

In an example, for use as a replacement server for the thin client server 201 or the operation server 301 (301a, 301b, 301c), a thin client server or an operation server (both not shown) may be ready in advance, and their servers and priorities may be entered in advance in the table 601. This accordingly enables priority control when the replacement server is put in use with any failure occurred to the thin client server 201 (201a, 201b), or the operation server 301 (301a, 301b).

Also in the embodiment, the operation client processing section the user is operating is acquired in the process 802. Alternatively, priorities may be determined based on the name of any active window or image information displayed on the window. If this is the case, the priorities may be increased when the display includes a text of “warning” or image information including an exclamation mark such as “!”, or when any failure occurred in the operation client processing section.

Also in this embodiment exemplifies a case where the business application is of a client-server type, i.e., in FIG. 1 example, the operation client processing section on the thin client server communicates with the operation server. The priority control system also may be considered in any communications service offering audio and video information such as one in which the operation server used for IP phone and PC conference system, for example, may serve as a management server, in view of communications with priorities.

Also in this embodiment, the priorities are determined based on a transmission-source device and a transmission-destination device. As alternatives to the transmission-source device and the transmission-destination device, the priorities may be determined based on an identifier assigned to the packet for indicating the type of communications. The identifier assigned to the packet for indicating the type of communications is exemplified by a port number in the IP network, for example. Alternatively, the priorities may be determined based on all of the above, i.e., the transmission-source device, the transmission-destination device, and the identifier assigned to the packet for indicating the type of communications.

Also in this embodiment, a computer system is exemplified as being a thin client system. This is surely not restrictive, and as long as a terminal is coupled to a server, and as long as screen information is used for communications between the terminal and the server as such, the thin client system is not the only option. The system of an image transfer type, i.e., the implementation of a thin client system in which input information is forwarded from a thin client terminal to a thin client server, and screen information is forwarded from the thin client server to the thin client terminal, includes server base, blade PC, virtual PC, and others. The thin client terminal is not restrictive, and any terminal will do as long as it can store, into an external storage device, information created by a user without restraint, e.g., fat client terminal.

Also in the above-discussed embodiment, the operation server 301 (301a, 301b, 301c) is included in the exemplary configuration, but is not necessarily included. If not, the operation client processing section A 204, the operation client processing section B 205, and the operation client processing section C 206 respond to a user's request without communicating with their corresponding operation servers 301 (301a, 301b, and 301c). The priority determination section 208 determines priorities in accordance with the processing section the user is operating.

Alternatively, the priority determination section 208 may determine the priorities in consideration of the quality or bandwidth of the network, or may perform communications with varying paths, e.g., using different paths between forward and backward. When the network varies in reliability due to multiplexing or the like, the network may be used in accordance with the priorities, i.e., the network that can perform communications with high reliability without fail may be used for transmission of any business application high in priority.

For monitoring of the network, in the system of FIG. 1, a management server may be separately provided or a management program may be provided in the thin client server, thereby performing priority control when the network congestion with a fixed level or higher is observed.

As shown by the above discussion, functions relating to the priority control system may be implemented on computers connected for data communication via the components of a packet data network, operating as one or more of the servers and/or as any of the terminals as shown in FIG. 1. Hence, aspects of the system or technique for priority control may be embodied in programming. A program aspect of the technology may be thought of as a “product” or an “article of manufacture” typically in the form of executable code and/or associated priority data that is carried on or embodied in a type of machine readable storage medium. “Storage” type media include any or all of the memory of various computers, processors or the like, or associated modules thereof, such as various semiconductor memories, tape drives, disk drives and the like, which may provide storage at any time for the relevant executable programming or data.

The specification and drawings are, accordingly, to be regarded in an illustrative rather than a restrictive sense. It will, however, be evident that various modifications and changes may be made thereto without departing from the spirit and scope of the invention or inventions as set forth in the claims.

What is claimed is:

1. A priority control system, comprising:
a plurality of terminals and at least one processing server coupled with the terminals over a network,
wherein the at least one processing server includes:
a plurality of operation processing sections each for executing a predetermined process;
a communications device;
a priority determination section; and
a priority assignment section,
wherein the at least one processing server is provided with priority information about priorities to be assigned in accordance with respective types of the operation processing sections,
wherein the operation processing sections each:
execute a respective predetermined process based on a packet provided by one of the terminals, and
generate terminal screen information to be displayed on the one terminal with a result of the respective predetermined process,
wherein the priority assignment section assigns, to the terminal screen information from the operation processing sections, the priorities determined in accordance with the respective types of the operation processing sections, and
wherein the communications device transmits the terminal screen information assigned with the priorities by the priority assignment section, the terminal screen information being transferred by a network device on the network in accordance with the priorities assigned to the terminal screen information, and being transmitted to the terminals for display.

2. The priority control system according to claim 1, wherein:
with the operation processing sections plurally provided,
the priority determination section determines any of the operation processing sections for assignment of the priorities in accordance with a state of use of the operation processing sections in the at least one processing server.

3. The priority control system according to claim 2, wherein:
the at least one processing server allocates a work area to each of the terminals,
the operation processing sections each operate on one of the work areas, and
the terminal screen information corresponds to the work areas.

4. The priority control system according to claim 3, wherein the state of use of the operation processing sections includes whether a window on a screen corresponding to each of the operation processing sections is active or not.

5. The priority control system according to claim 3, wherein the state of use of the operation processing sections includes whether a window on a screen corresponding to each of the operation processing sections is at the forefront or not.

6. The priority control system according to claim 3, wherein the state of use of the operation processing sections includes whether a failure is observed or not in a process to be executed by the operation processing sections.

7. In the priority control system according to claim 4, wherein:
when the network coupling the processing servers and the terminals is provided plurally, and
the processing servers change the networks for transmission of the terminal screen information in accordance with the priorities assigned to the terminal screen information.

8. The priority control system according to claim 1, wherein packets provided by the terminals are assigned priorities the same as those assigned to the terminal screen information, and are transferred by the network device in accordance with the priority information.

9. The priority control system according to claim 1, further comprising:
an operation server, wherein:
the operation processing sections execute respective predetermined processes through communications with the operation server, and
the network device:
includes, separately from the priority information being first priority information, second priority information about priorities to be determined in accordance with a transmission-source device of each packet and a transmission-destination device of each packet, and
transfers each packet to be exchanged between the operation processing sections and the operation server in accordance with the second priority information.

10. The priority control system according to claim 9, wherein the second priority information is provided with information about priorities to be determined by a communications type identifier also provided to a packet.

11. The priority control system according to claim 1, wherein the network device determines the transmission-source device and the transmission-destination device for the packet using an IP address of the transmission-source device and that of the transmission-destination device found in a packet.

12. The priority control system according to claim 11, wherein the communications type identifier is a port number.

13. The priority control system according to claim 9, further comprising a server for a replacement of the operation server.

14. The priority control system according to claim 1, wherein the operation processing sections each execute a process of accounting management or personnel appraisal management.

15. The priority control system according to claim 1, wherein the network device is a router.

16 An article of manufacture, comprising:
a machine readable storage medium; and
information embodied in said medium for processing by at least one computer configured as a server for communications via a network with one or more client terminals, the information comprising:
programming for a plurality of executable operation processing sections, wherein execution of each operation processing section causes said at least one computer to perform a respective predetermined process based on a packet received via the network from one of the client terminals and generate terminal screen information for display on the one client terminal based on a result of the respective predetermined process;
priority information about priorities of the respective predetermined processes performed by execution of the operation processing sections; and
programming for a priority processing section, wherein execution of the priority processing section causes said at least one computer to use the priority information to assign priorities to terminal screen information generated from execution of the operation processing sections in accordance with the respective types of the operation processing sections,
wherein, said at least one computer transmits the terminal screen information generated from execution of the operation processing sections and the assigned priorities through the network, to enable prioritized communications of the terminal screen information through the network to the client terminals for display.

17. A computer configured as a server implementing a priority control system for communications via a network with client terminals, the computer comprising:
a communication device for communications via the network;
a central processing unit;
a storage accessible by the central processing unit;
information contained in the storage, the information comprising:
programming for a plurality of executable operation processing sections, wherein execution of each operation processing section causes said at least one computer to perform a respective predetermined process based on a packet received via the network from one of the client terminals and generate terminal screen information for display on the one client terminal based on a result of the respective predetermined process;
priority information about priorities of the respective predetermined processes performed by execution of the operation processing sections; and
programming for a priority processing section, wherein execution of the priority processing section causes said at least one computer to use the priority information to assign priorities to terminal screen information generated from execution of the operation processing sections in accordance with the respective types of the operation processing sections,
wherein, the communication device transmits the terminal screen information generated from execution of the operation processing sections and the assigned priorities through the network, to enable prioritized communications of the terminal screen information through the network to the client terminals for display.
